(19) United States
(12) Patent Application Publication
(10) Pub. No.: US 2025/0162089 A1
(43) Pub. Date: May 22, 2025

(54) Apparatus, Systems and Methods for Delivery and Retraction of Fluids

(71) Applicant: Proteus Industries Inc., Mountain View, CA (US)

(72) Inventors: Mark R. Nicewonger, Mountain View, CA (US); Huy Anh Nguyen, Ho Chi Minh City (VN); Tiem Quang Nguyen, Ho Chi Minh City (VN); Hiep Ba Doan, Ho Chi Minh City (VN); Tung The Vu, Ho Chi Minh City (VN)

(21) Appl. No.: 19/032,601

(22) Filed: Jan. 21, 2025

Related U.S. Application Data
(63) Continuation-in-part of application No. 18/208,569, filed on Jun. 12, 2023, now Pat. No. 12,221,917.
Application No. 18/208,569 is a continuation-in-part of application No. 17/326,318, filed on May 20, 2021, now Pat. No. 11,674,722.
(60) Provisional application No. 63/027,896, filed on May 20, 2020.

(51) Int. Cl. B23K 37/003

(52) U.S. Cl. CPC B23K 37/003

(57) ABSTRACT

Apparatus, systems, and methods for controlling circulation of fluid to, and evacuation of the fluid from, an external fluid circuit for heat transfer. The apparatus includes a supply passageway for delivery of a liquid coolant to the external fluid circuit coupled to an external device, a bypass passageway having a venturi region that creates a suction force when liquid coolant passes therethrough, and fluid control means for selectively directing the circulation of coolant from the supply passageway to the external fluid circuit while stopping coolant to the bypass passageway, or diverting coolant to the bypass passageway while stopping circulation to the supply passageway and the external fluid circuit. A return passageway receives the circulation of coolant after passing through the external fluid circuit, and a suction passageway couples the suction force created by the venturi region to the return passageway, for evacuating fluid from the external fluid circuit. A return check valve disposed in the return passageway prevents backflow of liquid coolant through the return passageway.

### CROSS-REFERENCES TO RELATED APPLICATIONS

This application is a continuation-in-part of U.S. application Ser. No. 18/208,569, filed Jun. 12, 2023, which is a continuation-in-part of U.S. application Ser. No. 17/326,318, filed May 20, 2021, now U.S. Pat. No. 11,674,722, which claims priority to U.S. Provisional Application No. 63/027,896, filed May 20, 2020.

### FIELD OF THE INVENTION

The present invention(s) relate generally to heat exchanger systems. More particularly, the invention(s) relate to systems, apparatus and methods for controlling liquid coolant flow to and from an external device.

### BACKGROUND OF THE INVENTION

External heat developing apparatus and systems; particularly, resistance welding, i.e., spot welding, apparatus, typically require and, hence, employ heat-exchanger systems to regulate the temperature of the apparatus. Such heat-exchanger systems are typically adapted to circulate a liquid coolant to and from the welding electrodes to maintain the welding electrodes below a maximum temperature to prevent the electrodes from deforming due to excess heat, and hence, are often referred to as “liquid coolant control systems and apparatus.” It is well established that such deformation can, and often will, lead to defective or low-quality spot-welded joints and possible fusing of an electrode to sheet metal.

Various conventional liquid coolant control systems and apparatus have thus been developed to cool resistance welding apparatus and other systems. In such systems, the base end of the welding electrode is typically adapted to accommodate an internal circulation of liquid coolant, such as water, to remove heat from the electrode. The internal circulation of liquid coolant through the electrode is often blocked on a supply side to the electrode, and on a return side from the electrode, thereby creating an isolated section of the coolant flow path. This isolated section should ideally have zero fluid pressure, thereby accommodating removal of the electrode when the electrode is replaced for scheduled preventative maintenance, poor performance, or failure.

However, residual pressurized water can, and often does, remain in the isolated section of the coolant flow path, escape from a gap created in the coolant flow path, and spill out of the isolated section when the electrode is removed. This undesired liquid coolant spillage can create hazards for the welding equipment and any personnel in proximity to the spillage.

Although spillage from conventional liquid coolant control systems can be mitigated to some degree by shutting off liquid coolant flow at the source prior to the removal of a welding electrode, such a method of electrode removal is not optimal because spillage can still occur from the residual coolant present in the coolant system that has not been evacuated.

Many conventional coolant control systems for resistance welding apparatus thus include means to stop or minimize coolant spillage when a welding electrode is removed and/or a coolant leak develops proximate thereto. Such means, in several instances, comprise “mechanical” means, i.e., mechanical systems or apparatus, which is adapted to generate a suction force in a coolant line that is in communication with a welding electrode to evacuate coolant from the coolant line(s) prior to the removal of the electrode. Commonly employed “mechanical” means comprises piston-based systems, i.e., suction induced by movement of a piston in a cylinder.

A major drawback and disadvantage of such piston-based systems is that the effectiveness of such systems is limited by the fixed stroke of the piston, and therefore provide limited and often inadequate suction potential.

A further drawback and disadvantage of mechanical systems; particularly, piston-based systems, are the maintenance issues encountered due to contact of the liquid coolant with moving parts of such systems.

To overcome the drawbacks and disadvantages of “mechanical” means to stop or minimize coolant spillage when a welding electrode is removed and/or a coolant leak develops proximate thereto, various “non-mechanical” means have been developed to stop or minimize liquid coolant spillage when a welding electrode is removed and/or a coolant leak develops proximate thereto.

Such “non-mechanical” means typically comprise multiple valves, one in each of a plurality of fluid lines, which are adapted to control coolant flow to and from the welding electrode, including stopping coolant flow to the welding electrode and, hence, abating coolant spillage when the welding electrode is removed and/or a coolant leak develops proximate thereto.

Exemplar, highly effective “non-mechanical” means for controlling liquid coolant flow to and from a welding electrode are described in detail in U.S. Pat. No. 11,674,722 and priority Co-Pending U.S. application Ser. No. 18/208,569 to Applicant, i.e., Proteus Industries, Inc.

There remains however a need for improved coolant control systems and apparatus for resistance welding apparatus that effectively cool the welding electrode(s) and comprise effective means; preferably, non-mechanical means and associated control means for controlling coolant flow to and from the welding electrode(s), including stopping coolant flow to the welding electrode(s) and, abating coolant spillage when the welding electrode(s) is/are removed and/or a coolant leak develops proximate thereto.

It is therefore an object of the present invention to provide improved coolant control systems and apparatus for resistance welding apparatus, which substantially reduce or eliminate the disadvantages and drawbacks associated with conventional coolant control systems.

It is another object of the present invention to provide improved coolant control systems and apparatus for resistance welding apparatus that effectively cool the welding electrode(s) associated therewith and comprise highly effective means for controlling coolant flow to and from the welding electrode(s), including means for stopping coolant flow to the welding electrode(s) and, abating coolant spillage when the welding electrode(s) is/are removed and/or a coolant leak develops proximate thereto.

### SUMMARY OF THE INVENTION

The present invention is directed to systems, apparatus and methods for controlling a liquid coolant flow to and from an external device, such as a resistance welding apparatus, to cool the apparatus. In some embodiments of the invention, there is thus provided a coolant control apparatus for controlling the coolant flow to and from an external device.

In some embodiments, the coolant control apparatus comprises a three-way control valve that is coupled to an intake passageway to receive the coolant from an external coolant source, a supply passageway in fluid communication with an external fluid circuit for the delivery of the coolant to an external device, and a bypass passageway, and adapted to selectively stop circulation of the coolant to the external device, while simultaneously diverting the coolant through the bypass passageway, or vice versa, stop circulation of the coolant to the bypass passageway while simultaneously diverting the coolant through the external device. In either case, the coolant passing through the bypass passageway or the external fluid circuit is returned to the external source through a shared exhaust passageway, with the bypass passageway being directly coupled to the exhaust passageway, and the external fluid circuit being coupled to the exhaust passageway by a return passageway and a check valve to prevent a backflow of the coolant through the external device.

In some embodiments, the three-way control valve is further adapted to stop all coolant flow to all fluid passageways.

Thus, in some embodiments, no more than a single control valve and a single check valve are required in the apparatus to control coolant flow to and from the external device.

In some embodiments, the coolant control apparatus comprises dual two-way control valves acting in place of the 3-way control valve, i.e., a first two-way bypass control valve coupled between the fluid intake passageway and the fluid bypass passageway, which is adapted to control coolant flow into the fluid bypass passageway, and a second two-way supply control valve coupled between the fluid intake passageway and the supply passageway, which is adapted to control coolant flow to the external device. Such embodiments may further comprise a shared physical body for both the first and second two-way control valves and a single actuator adapted to simultaneously control both two-way control valves.

In a preferred embodiment, a venturi apparatus is disposed in the bypass passageway, the venturi apparatus comprising a venturi passageway with features adapted to create a suction force when there is a sufficiently high velocity of coolant flow passing through the venturi passageway.

In a further preferred embodiment, the venturi passageway comprises a venturi inlet in communication with a leading conical passageway having a gradually decreasing cross-sectional area, a trailing conical passageway having a gradually increasing cross-sectional area in communication with a venturi outlet, a fluid restriction therebetween whereby the suction force is created, and a suction inlet in communication with the fluid restriction.

In a preferred embodiment, the coolant control apparatus further comprises a suction passageway coupled to the suction inlet of the venturi apparatus, and is adapted to allow the suction force to be transferred to the external fluid circuit and evacuate at least a portion of the coolant from the external device.

In a further preferred embodiment, the suction passageway is in fluid communication with the return passageway for communication of suction force to the external fluid circuit.

In a further preferred embodiment, the coolant control apparatus further comprises a return check valve disposed between the return passageway and the exhaust passageway, and adapted to isolate the diverted coolant flow through the bypass passageway and exhaust passageway from the suction force coupled to the return passageway from the venturi apparatus, and also prevent any backflow of coolant from the exhaust passageway to the return passageway.

In some embodiments, the venturi apparatus further comprises a fluid jacket that (i) surrounds at least a portion of the venturi passageway, and (ii) is configured such that coolant within the fluid jacket is in communication with the low-pressure zone generated within the fluid restriction of the venturi passageway and the suction inlet, and (iii) is configured such that the suction passageway is coupled to the suction inlet and, thus, the fluid jacket instead of directly to the fluid restriction of the venturi passageway, thereby allowing the suction force from the fluid restriction to be transferred through the fluid jacket and suction passageway to the external fluid circuit. The suction inlet may be located at any point on the fluid jacket to allow for optimal placement of the suction passageway within the coolant control apparatus.

In some embodiments, the coupling of the fluid jacket to the low-pressure zone generated in the fluid restriction of the venturi passageway comprises at least one orifice between the fluid restriction and the fluid jacket, having a fixed cross-sectional area.

In a preferred embodiment, an open section or gap in the bypass flow path is disposed between the leading conical passageway, the outlet of which now comprises the fluid restriction, and the trailing conical passageway of the venturi passageway, whereby the suction force is generated in the gap and radially coupled to the fluid jacket. This radial coupling of up to 360 degrees provides a maximum cross-sectional coupling area, allowing for a least amount of restriction of coolant flow from the fluid jacket to the venturi passageway when an adequate flow of coolant through the venturi passageway produces a suction force in the gap.

In a preferred embodiment, no more than a single suction passageway is required to be coupled to either the supply passageway or return passageway in order to evacuate at least a portion of, or a sufficient quantity of, or all of the coolant from the external fluid circuit and the external device in order to prevent leakage from the external fluid circuit when the external device is detached from the coolant lines, or if any portion of the external fluid circuit is intentionally or accidentally disconnected or broken.

In some embodiments, a branch of the suction passageway or a second suction passageway is disposed to couple the venturi apparatus to both the supply passageway and the return passageway.

In some embodiments, the coolant control apparatus further comprises a suction check valve, which is disposed in the suction passageway and adapted to prevent a backflow of the coolant from the venturi apparatus to the external fluid circuit via the suction passageway and the return passageway when the coolant control apparatus is diverting the coolant flow through the bypass passageway, away from the external fluid circuit, but the coolant flow through the venturi apparatus is inadequate to create a suction force.

In some embodiments, wherein there is a sufficiently high velocity of coolant through the venturi apparatus when the coolant control apparatus is diverting the coolant flow through the venturi apparatus, no suction check valve is required in the suction passageway.

In some embodiments, the coolant control apparatus further comprises a second shutoff valve in a branch of the suction passageway or a second suction passageway that is coupled to the supply passageway. The second shutoff valve prevents an excess flow of the coolant from the supply passageway through the branch or second suction passageway to the venturi apparatus and onward to exit the coolant control apparatus through the exhaust passageway when the fluid control apparatus is delivering coolant from the supply passageway to the external cooling circuit.

In some embodiments, the coolant control apparatus further comprises a vent passageway that couples the supply passageway to atmospheric pressure to accommodate a more complete evacuation of coolant from the external fluid circuit when sufficient coolant flow is being diverted through the venturi apparatus to generate a suction force, with a vent check valve or vent control valve disposed in the vent passageway to prevent a loss of coolant when the coolant is being delivered to the external fluid circuit.

In at least one embodiment, the coolant control apparatus further comprises a single actuator that is adapted to operate the three-way control valve or two-way bypass and supply control valves, and optional suction and vent passageway valves. Although no more than a single actuator is required to operate the apparatus, in some embodiments, the coolant control apparatus may comprise multiple actuators that are adapted to operate the apparatus.

The Summary of the Invention set forth above is provided to introduce a selection of concepts in a simplified form that are further described below in the Detailed Description of the Invention. The Summary of the Invention is not intended to identify key or essential features of the claimed subject matter, nor is it intended to be used as an aid in determining the scope of the claimed subject matter.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1A is a schematic illustration of one embodiment of a coolant control apparatus where a three-way control valve communicates coolant flow from an intake passageway to a supply passageway and out to an external device before returning through a return passageway, return check valve and exhaust passageway;

FIG. 1B is a schematic illustration of the same embodiment of the coolant control apparatus shown in FIG. 1A, wherein the three-way valve diverts the coolant flow through a bypass passageway and a venturi apparatus and out through an exhaust passageway, whereby a suction is induced in the venturi apparatus and a resulting suction flow is communicated through a suction passageway to the return passageway to retract residual coolant from the external device;

FIG. 1C is again a schematic illustration of the same embodiment of the control apparatus shown in FIG. 1A, where an insufficient flow of coolant through the venturi device results in a loss of suction and a resultant backflow of coolant through the suction and return passageways;

FIG. 2A is a schematic illustration of a further embodiment of the coolant control apparatus shown in FIG. 1A, wherein a suction check valve is disposed in the suction passageway to abate the backflow of coolant to the return passageway when the venturi apparatus fails to create suction;

FIG. 2B is a schematic illustration of the coolant control apparatus shown in FIG. 2A, showing the normal suction flow of FIG. 1A being communicated through the suction check valve when the venturi apparatus creates suction;

FIG. 3A is a schematic illustration of a further embodiment of the coolant control apparatus shown in FIG. 1A, wherein the three-way control valve is replaced by dual two-way control valves with a first two-way valve delivering coolant flow to the external device while a second two-way valve blocks coolant flow from entering the bypass passageway;

FIG. 3B is a schematic illustration of the same embodiment of the coolant control apparatus shown in FIG. 3A with the first two-way valve blocking coolant flow to the external device while the second two-way valve delivers coolant flow to the bypass passageway;

FIG. 4A is a cross-sectional side plan view of an embodiment of a venturi apparatus 170 (now denoted “170a”) detailing internal features, as may be deployed in place of the venturi apparatus 170 depicted schematically in FIGS. 1A-3B, where coolant flow enters a venturi inlet into a leading conical passageway and exits a venturi outlet from a trailing conical passageway with a fluid restriction therebetween, where a suction force is created and communicated to a suction inlet of the venturi apparatus;

FIG. 4B is a cross-sectional side plan view of an embodiment of a venturi apparatus 170 (now denoted “170b”) detailing internal features, as may be deployed in place of the venturi apparatus 170 depicted schematically in FIGS. 1A-3B, where a fluid jacket is introduced to communicate suction from the fluid restriction to an axially positioned suction inlet;

FIG. 4C is a cross-sectional side plan view of another embodiment of the venturi apparatus 170b shown in FIG. 4B, wherein the fluid jacket comprises a radially positioned suction inlet;

FIG. 4D is a cross-sectional side plan view of an embodiment of a venturi apparatus 170 (now denoted “170c”) detailing internal features, as may be deployed in place of the venturi apparatus 170 depicted schematically in FIGS. 1A-3B, introducing a radial gap between the leading and trailing conical passageways whereby suction is communicated to the fluid jacket and suction inlet;

FIG. 4E is a partial cross-sectional side plan view of the same embodiment of the venturi apparatus 170c as shown in FIG. 4D;

FIG. 4F is a cross-sectional side plan view of an embodiment of a venturi apparatus 170 (now denoted “170d”) detailing internal features, as may be deployed in place of the venturi apparatus 170 depicted schematically in FIGS. 1A-3B, introducing a concentric gap between the leading and trailing conical passageways whereby suction is communicated to the fluid jacket and suction inlet;

FIG. 5A is a cross-sectional side plan view of one embodiment of the coolant control apparatus 100a corresponding to the schematic illustration of FIG. 1A, shown delivering coolant flow to an external device incorporating a venturi apparatus 170c as shown in FIG. 4D including a fluid jacket and radial gap, and employing a poppet-style return check valve;

FIG. 5B is a cross-sectional side plan view of the embodiment of the coolant control apparatus 100a corresponding to the schematic illustration of FIG. 1B, shown diverting coolant through the venturi apparatus 170c of FIG. 4D including a fluid jacket and radial gap, and employing a poppet-style return check valve;

FIG. 5C is a cross-sectional side plan view of a preferred embodiment of the coolant control apparatus 100a corresponding to the schematic illustration of FIG. 1A, shown delivering coolant flow to an external device incorporating a venturi apparatus 170c as shown in FIG. 4D including a fluid jacket and radial gap, and employing a swing-style return check valve; and

FIG. 5D is a cross-sectional side plan view of a preferred embodiment of the coolant control apparatus 100a corresponding to the schematic illustration of FIG. 1B, shown diverting coolant through the venturi apparatus 170c of FIG. 4D including a fluid jacket and radial gap, and employing a swing-style return check valve.

### DETAILED DESCRIPTION OF THE PREFERRED EMBODIMENT

Before describing the present invention in detail, it is to be understood that this invention is not limited to particularly exemplified systems, apparatus, structures or methods as such may, of course, vary. Thus, although a number of systems, apparatus, structures and methods similar or equivalent to those described herein can be used in the practice of the present invention, the preferred systems, apparatus, structures and methods are described herein.

It is also to be understood that the systems, apparatus, methods, operations and processes disclosed herein can be implemented in any means for achieving various aspects, and can be executed in a form of a machine-readable medium, and/or a machine accessible medium, embodying a set of instructions that, when executed by a machine or a data processing system (e.g., a computer system), in one or more different sequences, cause the machine to perform any of the operations disclosed herein. Accordingly, the specification and drawings are to be regarded in an illustrative manner rather than a restrictive sense.

It is also to be understood that the terminology used herein is for the purpose of describing particular embodiments of the invention only and is not intended to be limiting.

Where a definition or use of a term in a reference, which is incorporated by reference herein, is inconsistent or contrary to the definition of that term provided herein, the definition of that term provided herein applies and the definition of that term in the reference does not apply.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

### List of Reference Designators

The following references are employed in the drawings and used in the following descriptions of embodiments of the systems, apparatus and methods to circulate and evacuate liquid coolant from a heat exchanger system of the invention. It is to be understood that the same reference numbers in the drawings indicate like elements throughout the drawings and the descriptions.

| Reference Number(s) | Reference Designator |
|---|---|
| 100a, 100b, and 100c | coolant control apparatus |
| 101 | fluid jacket |
| 102 | suction inlet |
| 103 | venturi orifice |
| 104 | intake passageway |
| 105 | coolant reservoir |
| 106 | bypass passageway |
| 107 | venturi passageway |
| 108 | return passageway |
| 109 | exhaust passageway |
| 110 | source inlet |
| 112 | supply outlet |
| 114 | supply passageway |
| 116 | suction passageway |
| 117 | suction check valve |
| 120 | exhaust outlet |
| 122 | return inlet |
| 126 | valve actuator |
| 130 | three-way control valve |
| 131 | valve diaphragm |
| 132 | return check valve |
| 132a | return check valve poppet |
| 132b | return check valve swing gate |
| 133 | leading conical passageway |
| 134 | fluid restriction |
| 135 | trailing conical passageway |
| 136 | low-pressure zone |
| 137 | two-way bypass control valve |
| 138 | atmospheric pressure |
| 139 | two-way supply control valve |
| 140 | coolant flow |
| 141 | coolant + suction flow |
| 142 | suction flow |
| 143 | suction backflow |
| 144 | incidental flow |
| 146 | coolant + incidental flow |
| 147 | insufficient flow |
| 148 | radial gap |
| 149 | annular gap |
| 151 | jetting outlet |
| 152 | receiving inlet |
| 153 | venturi inlet |
| 154 | venturi outlet |
| 155 | suction force |
| 170, 170a, 170b, 170c, and 170d | venturi apparatus |
| 200, 201 | external flow lines |
| 210 | external fluid circuit |
| 300 | external device |

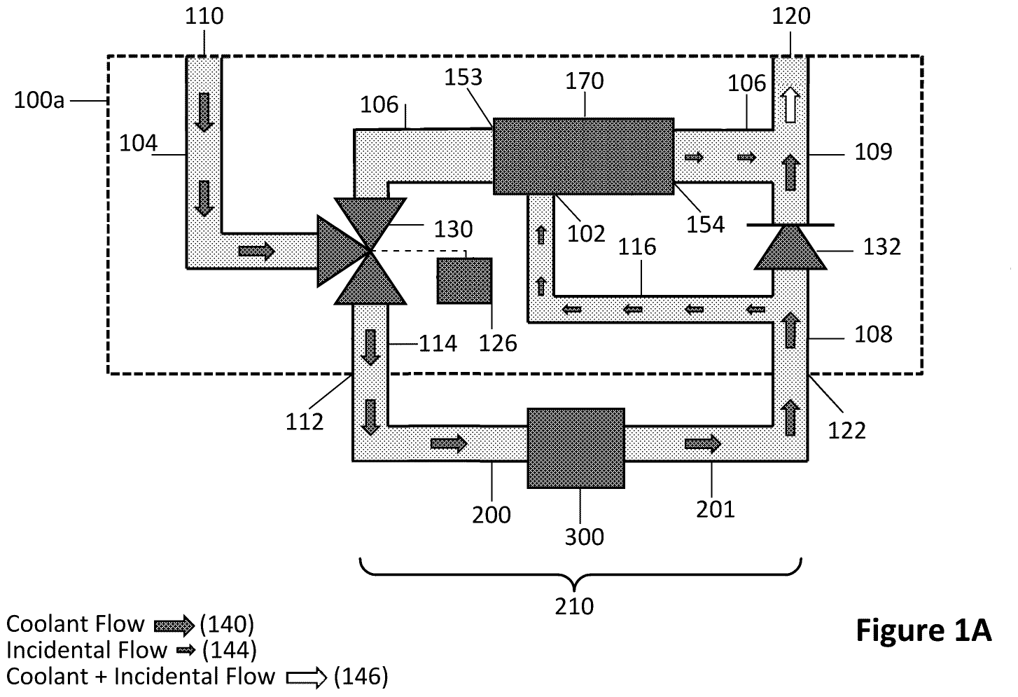

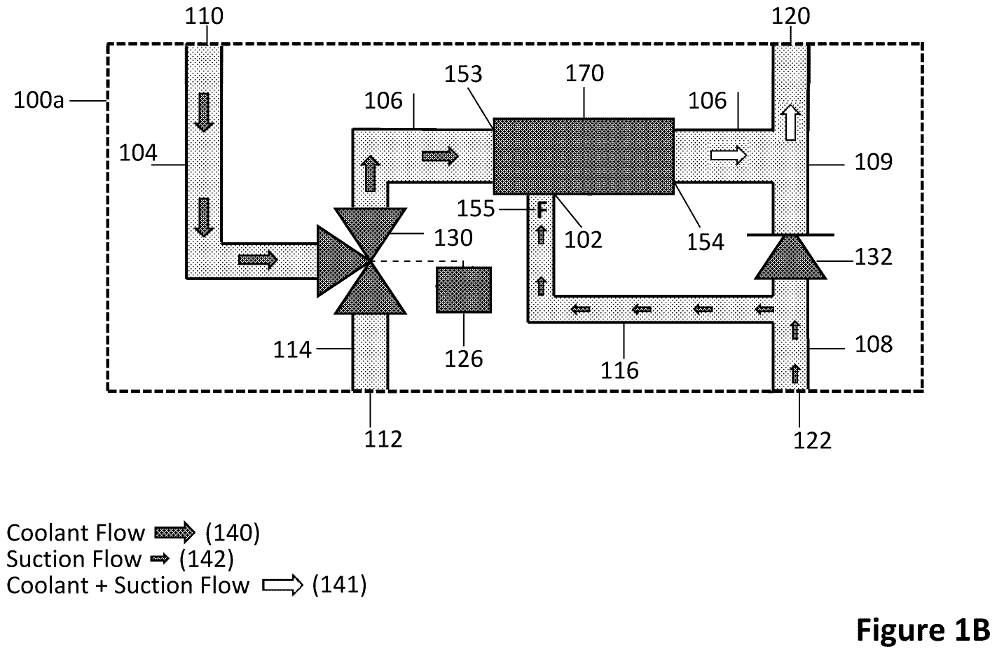

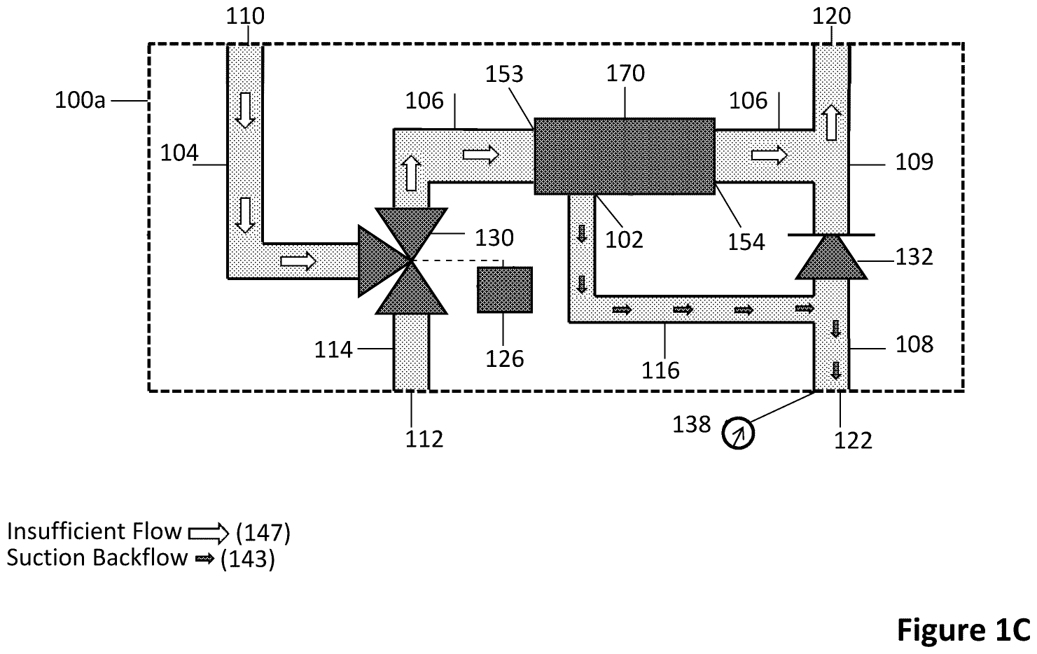

Referring first to FIG. 1A, there is illustrated a first embodiment of a coolant control apparatus of the invention (denoted “100a”). As discussed in detail in priority application Ser. No. 17/326,318, now U.S. Pat. No. 11,674,722, the coolant control apparatus 100a controls a liquid coolant flow 140 to and from an external fluid circuit 210 comprising at least one set of external flow lines 200 and 201 and an external device 300.

As illustrated in FIG. 1A, the coolant flow 140 enters the apparatus 100a at a source inlet 110 and flows through an intake passageway 104 to a three-way control valve 130, which is adapted to selectively (i) allow the coolant flow 140 to continue through a supply passageway 114, leaving the coolant control apparatus 100a out of a supply outlet 112, and continuing into the external fluid circuit 210 or (ii) divert the coolant flow 140 into and through a bypass passageway 106, with a venturi apparatus 170 disposed therein, and onward through an exhaust passageway 109 and out of the apparatus 100a through an exhaust outlet 120.

As set forth in priority application Ser. No. 17/326,318, now U.S. Pat. No. 11,674,722, the three-way control valve 130 is further adapted to selectively block the coolant flow 140 entering the source inlet 110 from entering into the supply passageway 114 or bypass passageway 106.

As further illustrated in FIG. 1A, after passing through the external fluid circuit 210, the coolant flow 140 re-enters the coolant control apparatus 100a at a return inlet 122, and passes through a return passageway 108, return check valve 132, and exhaust passageway 109 before finally being discharged from the coolant control apparatus 100a at an exhaust outlet 120.

As also illustrated in FIG. 1A, an incidental flow 144 of the coolant can also pass through a suction passageway 116 where it continues through the venturi apparatus 170, the bypass passageway 106 and exhaust passageway 109 to also be discharged from the coolant control apparatus 100a at exhaust outlet 120 along with the coolant flow 140.

As further illustrated in FIG. 1A, the coolant control apparatus 100a further comprises a return check valve 132, which is coupled to the return passageway 108 and exhaust passageway 109. The return check valve 132 is adapted to prevent a backflow of the coolant from the exhaust passageway 109 to the return passageway 108 and return inlet 122.

Referring now to FIG. 1B, in a preferred embodiment of the coolant control apparatus 100a, the venturi apparatus 170 comprises a venturi inlet 153, venturi outlet 154 and suction inlet 102, and is adapted to create a suction force 155 at the suction inlet 102 as further described below when the three-way control valve 130 diverts a sufficiently high velocity of coolant flow 140 through the venturi apparatus 170 from the venturi inlet 153 to the venturi outlet 154.

The suction inlet 102 of the venturi apparatus 170 couples the suction force 155 to the suction passageway 116, which results in a suction flow 142 through the suction passageway 116 when the return inlet 122 or any part of the attached external fluid circuit 210 (not shown) is at least partially open to atmosphere. The suction flow 142 draws at least a portion of coolant from the return passageway 108 through the suction passageway 116 and into the venturi apparatus 170, where the combined coolant +suction flow 141 continues through the bypass passageway 106 and into the exhaust passageway 109 to exit the coolant control apparatus 100a at the exhaust outlet 120.

According to the invention, the three-way control valve 130 can be operated by hand or by a valve actuator 126, with motive force coming from a variety of sources, such as pneumatic, hydraulic, electrical, or by the motion of a robot, as discussed in detail herein.

According to the invention, various conventional means can be employed to facilitate the disposition of the venturi apparatus 170 within the bypass passageway 106 or other passageways of the coolant control apparatus of the invention, to provide a further embodiment of a venturi region of the invention.

Referring now to FIG. 1C, when an insufficiently high velocity of coolant flow 140 (now denoted “147”) is being diverted through the venturi apparatus 170, the venturi apparatus 170 will fail to create suction, resulting in a suction backflow 143 of coolant from the suction inlet 102 of the venturi apparatus 170 into the suction passageway 116 and return passageway 108 to escape from the coolant control apparatus 100a when the return inlet 122 or attached external flow circuit 210 (not shown) is at least partially open to the atmosphere.

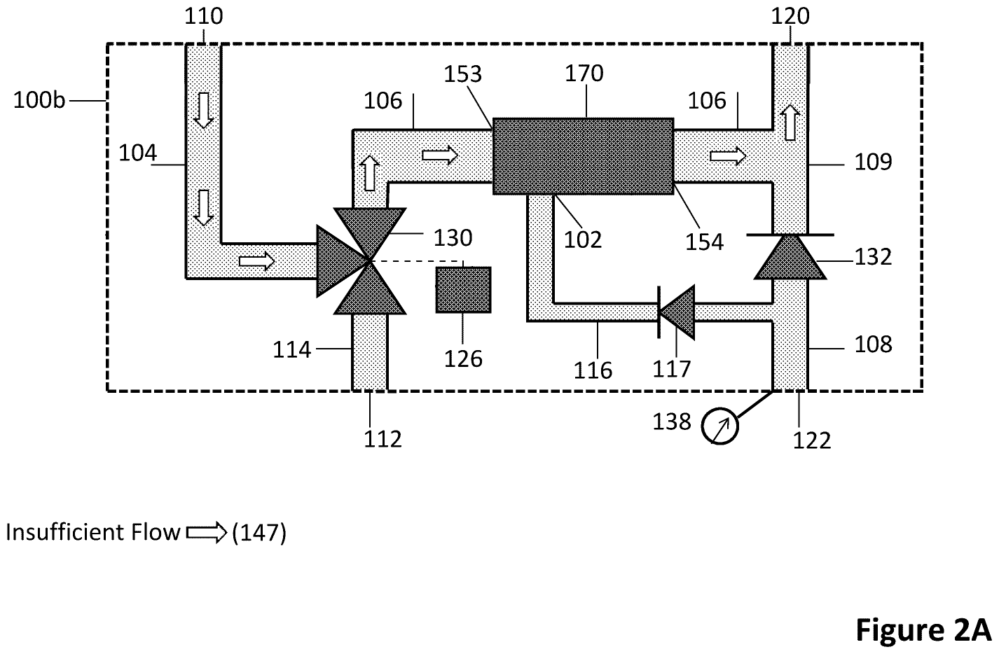

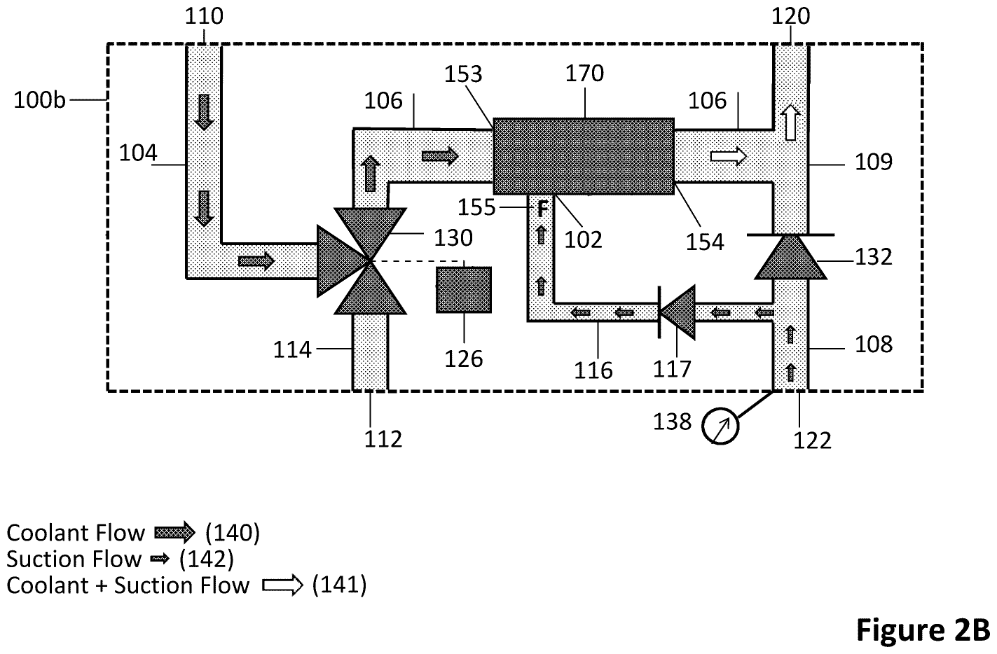

As illustrated in FIG. 2A, some embodiments of the coolant control apparatus 100a (now denoted “100b”) further comprise a suction check valve 117 that is disposed in the suction passageway 116. The suction check valve 117 is adapted to prevent the occurrence of suction backflow 143 through the suction passageway 116 and return passageway 108 and coolant escape when there is insufficient flow 147 through the venturi apparatus 170, and the return inlet 122 or attached external fluid circuit 210 (not shown) is at least partially open to the atmospheric pressure 138.

As illustrated is FIG. 2B, the suction check valve 117 is further adapted to allow a suction flow 142 of a portion of the coolant that is contained in the return passageway 108 to be drawn through the suction passageway 116 when the coolant flow 140 passing through the venturi apparatus 170 is sufficient to create suction force 155 and resultant suction flow 140 of a least a portion of coolant in the return passageway 108 and the return inlet 122 or attached external fluid circuit 210 (not shown) is at least partially open to the atmospheric pressure 138.

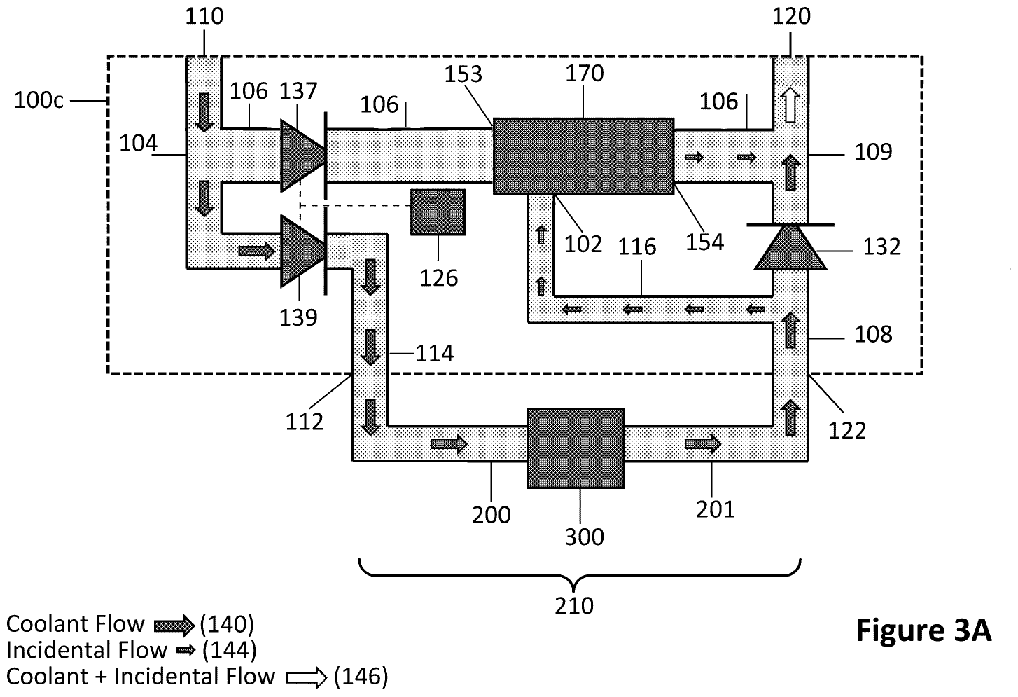

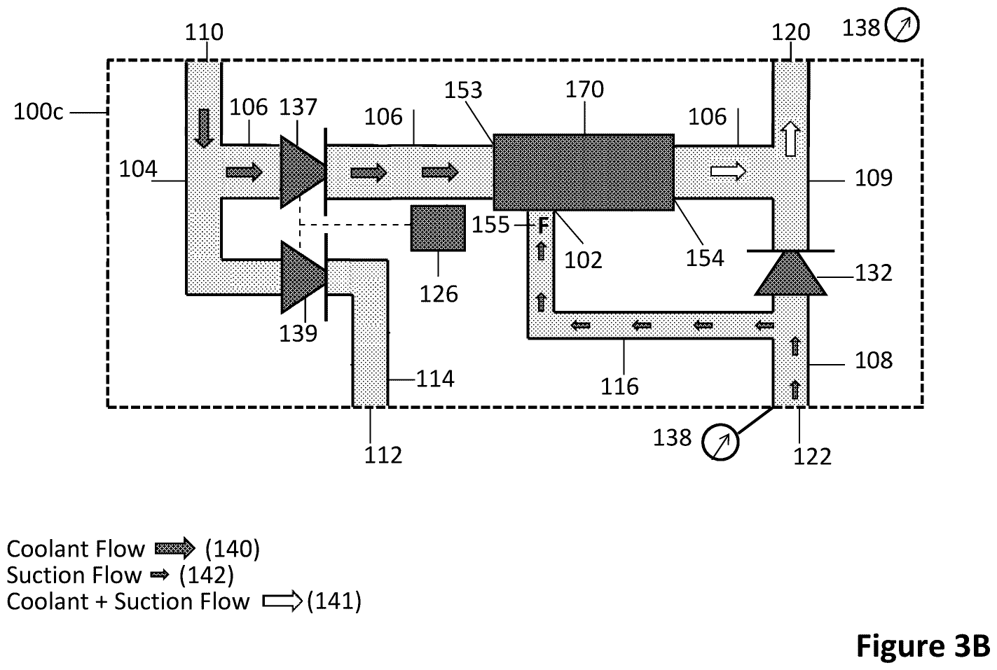

Referring now to FIGS. 3A-3B, there are illustrated further embodiments of the coolant control apparatus 100a illustrated in FIG. 1A (now denoted “100c”).

As illustrated in FIGS. 3A and 3B, the coolant control apparatus 100c similarly comprises the source inlet 110, intake passageway 104, supply passageway 114, supply outlet 112, bypass passageway 106, venturi apparatus 170, return inlet 122, return passageway 108, suction passageway 116, return check valve 132, exhaust passageway 109, and exhaust outlet 120.

However, as illustrated in FIGS. 3A-3B, the three-way control valve 130 is replaced with dual two-way control valves, namely a two-way bypass control valve 137 coupled to the intake passageway 104 and the bypass passageway 106, and a two-way supply control valve 139 coupled to the intake passageway 104 and the supply passageway 114.

As further illustrated in FIG. 3A, according to the invention, when the two-way supply control valve 139 is in an open position and the two-way bypass control valve 137 is in a closed position, the coolant flow 140 that enters the coolant control apparatus 100c at the source inlet 110 is allowed to flow through the intake passageway 104 and onward through the supply passageway 114 that is coupled to the external fluid circuit 210 at the supply outlet 112.

After passing through the external fluid circuit 210, the coolant flow 140 reenters the coolant control apparatus 100c at the return inlet 122 to continue onward through the return passageway 108, return check valve 132 and outlet passageway 109 before finally exiting the coolant control apparatus 100c at the exhaust outlet 120.

As also illustrated in FIG. 3A, the suction passageway 116 referenced above is similarly coupled to the suction inlet 102 of the venturi apparatus 170 and the return passageway 108, and an incidental flow 144 of the coolant can pass from the return passageway 108 through the suction passageway 116 where it continues through the venturi apparatus 170, the bypass passageway 106 and exhaust passageway 109 to also be discharged from the coolant control apparatus 100c at the exhaust outlet 120 along with the coolant flow 140.

As illustrated in FIG. 3B, according to the invention, when the two-way bypass control valve 137 is in an open position and the two-way supply control valve 139 is in a closed position, the coolant flow 140 that enters the apparatus 100c at the source inlet 110 is allowed to flow through the intake passageway 104 and onward through the bypass passageway 106, the venturi apparatus 170 and the exhaust passageway 109, and exit out of the coolant control apparatus 100c through the exhaust outlet 120.

As additionally illustrated in FIG. 3B, according to the invention, when the two-way supply control valve 139 is in a closed position and the two-way bypass control valve 137 is in an open position and a sufficiently high velocity of coolant flow 140 is passing through the venturi apparatus 170, suction force 155 created by the venturi apparatus 170 causes a suction flow 142 of a portion of the coolant contained in the return passageway 108 to be drawn through the suction passageway 116 when the return inlet 122 or attached external fluid circuit 210 (not shown) is at least partially open to the atmospheric pressure 138, and into the venturi apparatus 170 where the combined coolant+suction flow 141 continues through the bypass passageway 106 to be discharged from the apparatus 100c through the exhaust passageway 109 and exhaust outlet 120.

According to the invention, the two-way supply and bypass control valves 139, 137 are further adapted to abate the flow of the coolant flow 140 entering source inlet 110 from entering the external fluid circuit 210 and bypass passageway 106, when both two-way valves 139, 137 are in closed positions.

According to the invention, the two-way supply and bypass control valves 139, 137 can also comprise a single integral unit comprising the same functions as the individual two-way valves 139, 137 illustrated in FIGS. 3A-3B and discussed in detail above. According to the invention, the single integral unit can also be controlled by a single valve actuator 126.

According to the invention, further embodiments of the coolant control apparatus 100c illustrated in FIGS. 3A-3B can also include the suction check valve 117 disposed in the suction passageway 116 as employed in the coolant control apparatus 100b depicted in FIGS. 2A-2B, and functioning as described above for the coolant control apparatus 100b.

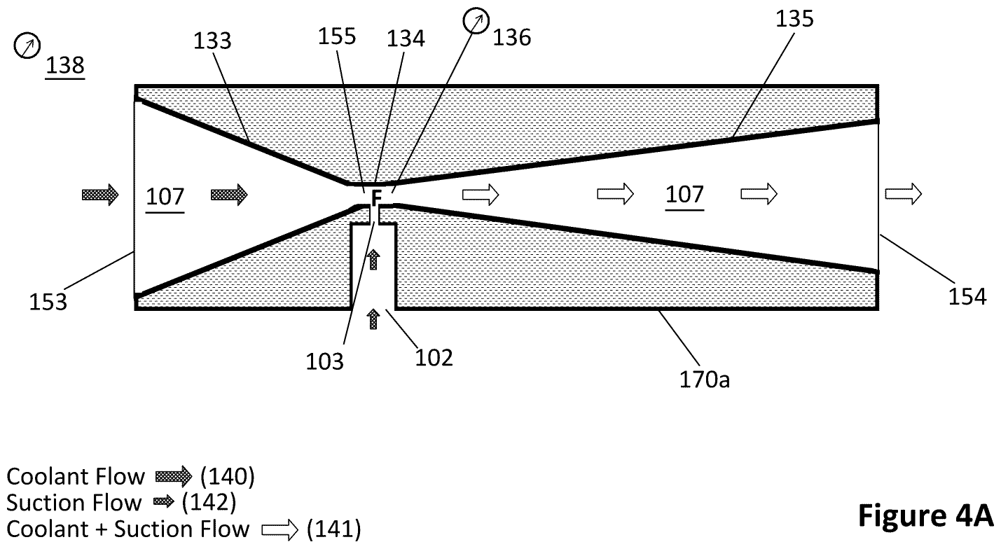

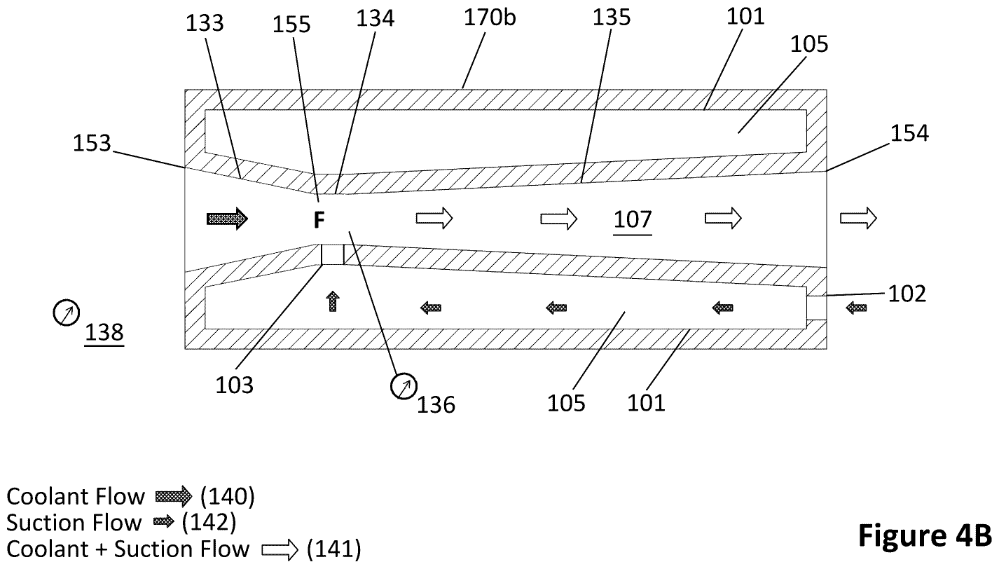

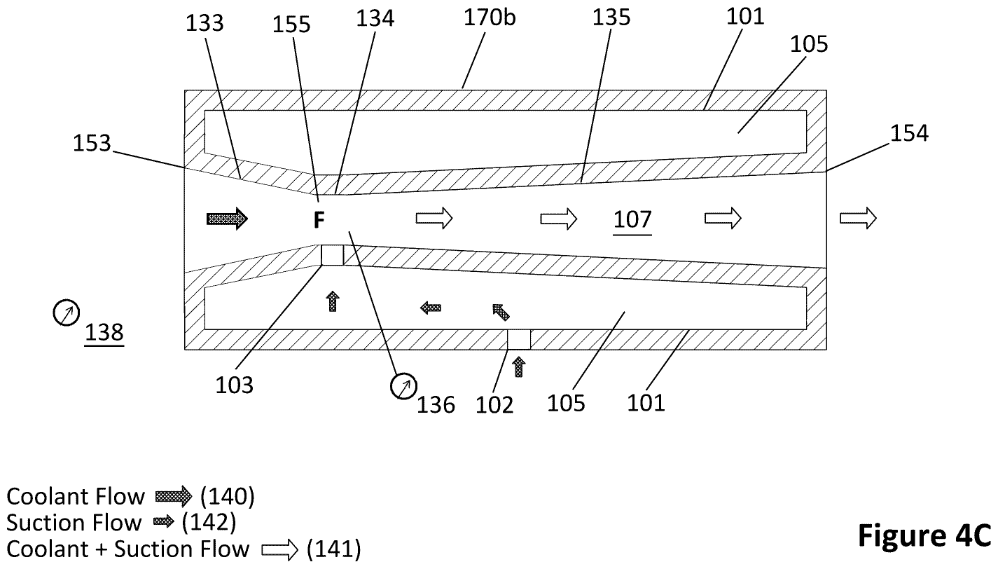

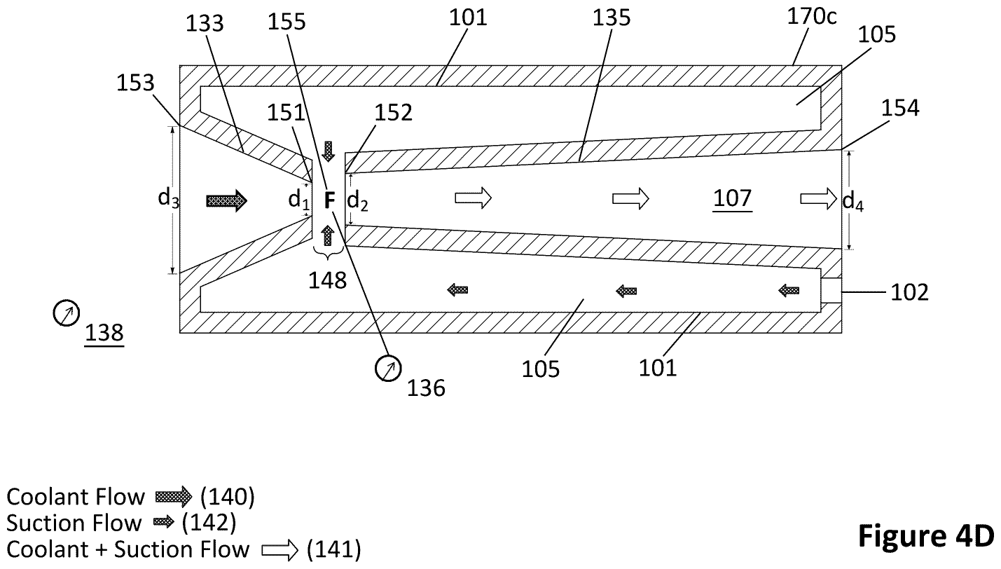

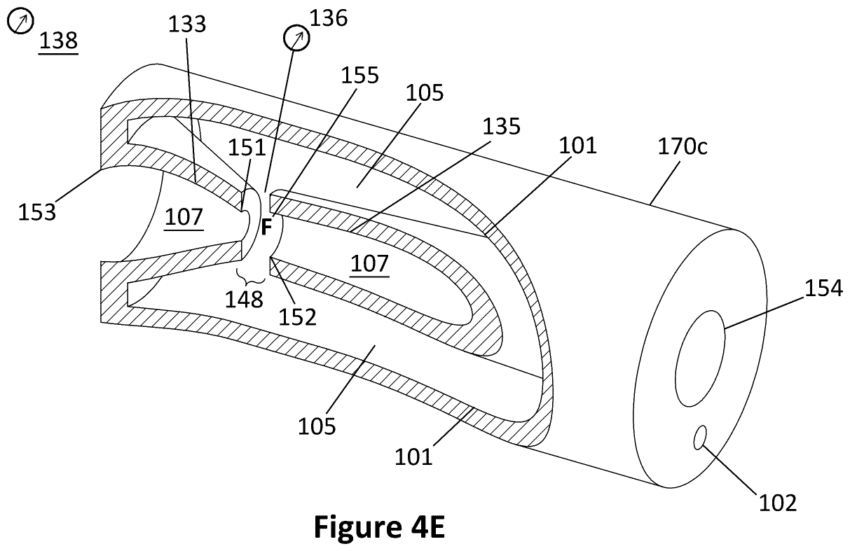

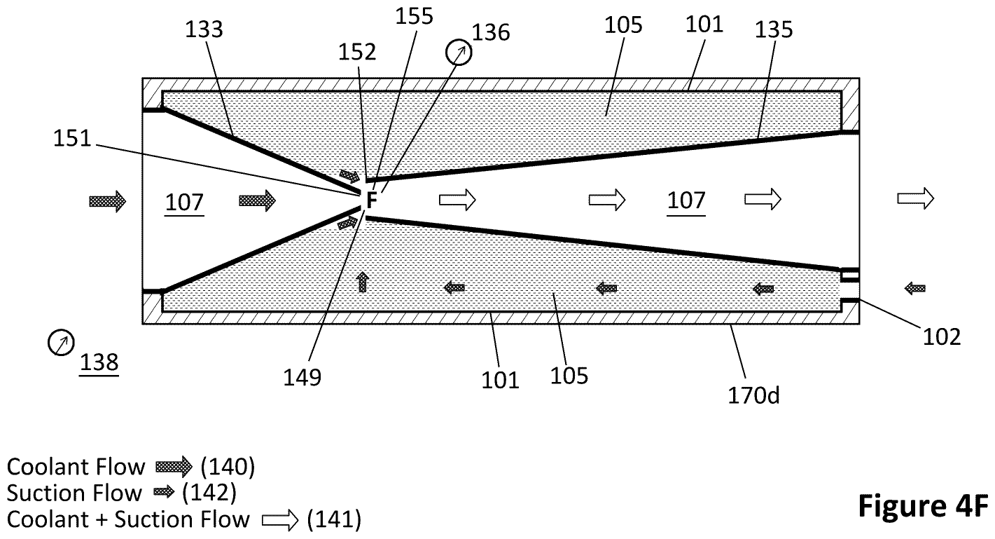

Referring now to FIGS. 4A-4F, there are shown several embodiments of the venturi apparatus 170 of the invention (denoted “170a-170d”), which, as discussed in detail below, depict various means of fluid communication between the coolant flow 140 passing through the venturi apparatus 170 and the suction flow 142 or incidental flow 144 entering the venturi apparatus 170 through the suction inlet 102.

As illustrated in FIGS. 4A-4F, all preferred embodiments of the venturi apparatus 170a-170d comprise a venturi inlet 153, a venturi outlet 154, and a venturi passageway 107 disposed in communication therebetween which, as discussed below, is adapted to create a suction force 155 coupled to a suction inlet 102 when there is a sufficiently high velocity of coolant flow 140 through the venturi passageway 107.

In preferred embodiments, the venturi passageway 107 comprises a leading conical passageway 133 having a gradually decreasing cross-sectional area from the venturi inlet 153 through which the coolant flow 140 enters, a trailing conical passageway 135 having a gradually increasing cross-sectional area to the venturi outlet 154 whereby the coolant flow 140 exits, and a fluid restriction 134 disposed therebetween and coupled to the suction inlet 102, whereby a sufficiently high velocity of coolant flow 140 through the venturi passageway 107 creates a low-pressure zone 136 at the fluid restriction 134 having a pressure of the coolant that is less than the surrounding atmospheric pressure 138 and a resulting suction force 155 coupled to the suction inlet 102, by which suction flow 142 is induced.

In preferred embodiments, the suction inlet 102 and coupling to the fluid restriction 134 are positioned in a radially downward direction relative to the longitudinal axis of the venturi passageway 107.

According to the invention, the downward orientation of the suction inlet 102 and coupling to the fluid restriction 134 facilitates drainage of the liquid coolant from the venturi apparatus 170 when the coolant control apparatus of the invention is disconnected and not in use, as may be the case for storage or transport. Thus, when not in use, the noted drainage of the coolant provided by the downward orientation of the suction inlet 102 and coupling to the fluid restriction 134 substantially reduces the possibility of damage to the venturi apparatus 170 due to ice formation.

Referring specifically now to one embodiment of the venturi apparatus 170 (now denoted “170a”) illustrated in FIG. 4A, the suction inlet 102 of the venturi apparatus 170a is coupled directly to a venturi orifice 103 disposed at the fluid restriction 134, whereby the suction force 155 created at the fluid restriction 134 is communicated to the suction inlet 102. The venturi orifice 103 is sized for an optimal creation and transfer of the suction force 155 and maximum suction flow 142 into the venturi apparatus 170a.

Referring now to FIGS. 4B and 4C, there is illustrated a further embodiment of the venturi apparatus 170 (now denoted “170b”), that further comprises one embodiment of a fluid jacket (denoted “101”) through which suction force 155 and resulting suction flow 142 is communicated between the suction inlet 102 and the venturi orifice 103 to the fluid restriction 134 of the venturi passageway 107.

As set forth in priority Co-pending U.S. application Ser. No. 18/208,569, which is incorporated by reference herein in its entirety, and illustrated in FIGS. 4B and 4C, the fluid jacket 101 is preferably sized and configured to surround at least a portion, but more preferably all, of the fluid restriction 134, as well as portions, if not all, of the leading conical passageway 133, and trailing conical passageway 135 of the venturi passageway 107.

As further illustrated in FIGS. 4B and 4C, the fluid jacket 101 is further sized and configured to receive and contain a coolant reservoir 105 therein, whereby suction flow 142 is communicated between the suction inlet 102 and the venturi orifice 103 to the fluid restriction 134 through the coolant reservoir 105, with the venturi orifice 103 sized for an optimal creation and transfer of the suction force 155 and maximum suction flow 142 through the venturi apparatus 170b.

As additionally illustrated in FIGS. 4B and 4C, in a preferred embodiment, the suction flow 142 passes from the suction inlet 102 through the fluid jacket 101 and venturi orifice 103 to the fluid restriction of the venturi passageway 107, where the combined coolant+suction flow 141 continues on to be discharged through the venturi outlet 154.

As also set forth in priority Co-pending U.S. application Ser. No. 18/208,569, the suction inlet 102 can be positioned either axially to the longitudinal axis of the venturi passageway 107 at any position on the fluid jacket 101, as illustrated here in FIG. 4B, or radially at any external point on the fluid jacket 101, as illustrated here in FIG. 4C.

According to the invention, coupling of the fluid restriction 134 to the suction inlet 102 via the fluid jacket 101 does not require the outer perimeter of the venturi passageway 107 to include an outer annular groove to couple the suction force 155 generated at the fluid restriction 134 to the suction inlet 102.

According to the invention, the diameter of the venturi inlet 153 can be equal to or greater than the diameter of the venturi outlet 154. In a preferred embodiment, the diameter of the venturi inlet 153 is greater than the diameter of the venturi outlet 154.

Further referring to FIGS. 4B and 4C, the venturi apparatus 170b includes (i) the abovementioned fluid restriction 134 to provide for the communication of coolant flow 140 between the leading and trailing conical passageways 133 and 135 and (ii) at least one venturi orifice 103 to provide for the communication of suction flow 142 between the coolant reservoir 105 contained within the fluid jacket 101 and coolant flow 140 passing through the venturi passageway 107.

Referring specifically now to FIGS. 4D and 4E, there is shown a preferred embodiment of the venturi apparatus of the invention (denoted “170c”), which is similarly configured and adapted to create a low-pressure zone 136 and, hence, suction force 155 with resultant suction flow 142 when there is a sufficiently high velocity of coolant flow 140 therethrough.

As illustrated in FIGS. 4D and 4E, the venturi apparatus 170c similarly comprises a fluid jacket 101 that surrounds a venturi passageway 107, with the fluid jacket 101 similarly sized and configured to receive and contain a coolant reservoir 105 therein, providing fluid communication between the suction inlet 102 and the venturi passageway 107.

In this preferred embodiment illustrated in FIGS. 4D and 4E, the leading conical passageway 133, trailing conical passageway 135 and a radial (or concentric) gap (or opening) 148 disposed therebetween define the internal venturi passageway 107 to accommodate liquid coolant flow 140 through the venturi apparatus 170c. In this embodiment, a jetting outlet 151 of the leading conical passageway 133 functions as the fluid restriction 134 shown in FIGS. 4B and 4C and the radial gap 148 disposes the need for the venturi orifice 103 shown in FIGS. 4B and 4C.

According to the invention, when there is a sufficiently high velocity of coolant flow 140 through the venturi passageway 107, the coolant flow 140 will jet across the radial gap 148 from the leading conical passageway 133 to the trailing conical passageway 135, with a resulting low pressure zone 136 being created at the jetting outlet 151 and propagated across the radial gap 148 and into the fluid jacket 101, whereby the suction force 155 created will induce a suction flow 142 of coolant from the suction inlet 102 through the coolant reservoir 105 and into the radial gap 148 to combine with the coolant flow 140 jetting across the radial gap 148 where the combined coolant +suction flow 141 continue into the trailing conical passageway 135.

In contrast to the fixed venturi orifice 103 of venturi apparatus 170a-170b depicted in FIGS. 4A-4C, the radial gap 148 depicted in FIGS. 4D and 4E provides 360 degrees of coupling between the fluid reservoir 105 and the low pressure zone 136 created at the jetting outlet 151, which results in a lower resistance and greater capacity of suction flow 142 from the fluid reservoir 105 to the low pressure zone 136, and thereby increased suction flow 142.

According to the invention, the diameter d₁ of the jetting outlet 151 of the leading conical passageway 133, can be equal to or, in a preferred embodiment, as illustrated in FIGS. 4D and 4E, less than the diameter d₂ of a receiving inlet 152 of the trailing conical passageway 135, which, according to the invention, provides for the jetting of coolant flow 140 from the leading conical passageway 133 to the trailing conical passageway 135 with optimal laminar flow characteristics of the coolant flow 140 across the radial gap 148 and through the trailing conical passageway 135 of the venturi passageway 107.

The diameter d₃ of the venturi inlet 153 of the leading conical passageway 133, does not need to be less than, but can also be equal to or, as illustrated in FIGS. 4D and 4E, optimally greater than the diameter d₄ of the venturi outlet 154 of the trailing conical passageway 135.

FIG. 4E provides a three-dimensional depiction of the venturi apparatus 170c, partially cut away to reveal the internal features of the venturi passageway 107 within the fluid jacket 101 with the suction inlet 102, and the placement of the leading conical passageway 133 and trailing conical passageway 135 to form the radial gap 148, featuring the jetting outlet 151 and receiving inlet 152, as well as the venturi inlet 153 and venturi outlet 154.

In a preferred embodiment of the venturi apparatus 170c, the relationships between the width of the radial gap 148 and the diameters d₁ and d₂ of the jetting outlet 151 and receiving inlet 152 are optimized for the best balance of jetting of the coolant flow 140 across the radial gap 148 and maximization of the suction flow 142.

However, in other embodiments of the venturi apparatus 170c (now denoted “170d” and depicted in FIG. 4F), the width of the radial gap 148 between the leading conical passageway 133 and trailing conical passageway 135 is decreased to a point approaching zero, while the diameter d₂ of the receiving inlet 152 of the trailing conical passageway 135 is correspondingly increased to a point where the radial gap 148 becomes an annular gap 149 around the outside of the smaller end of the leading conical passageway 133.

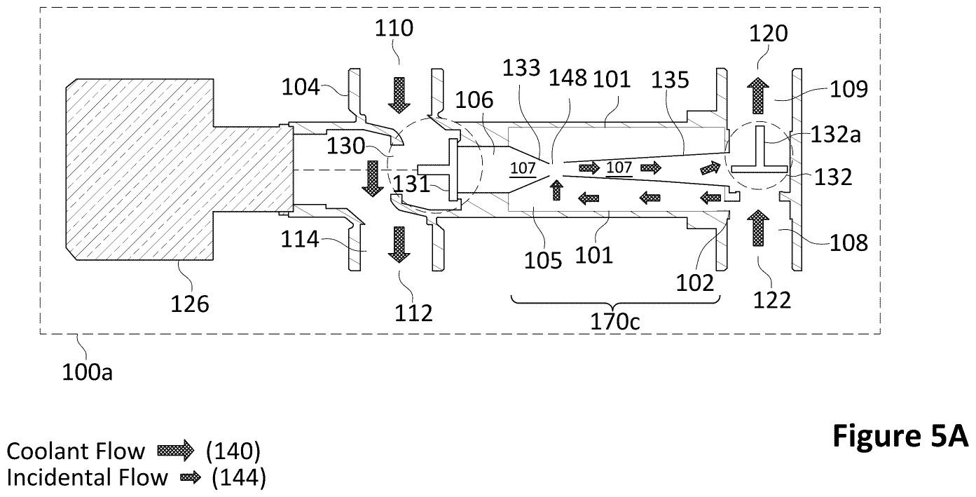

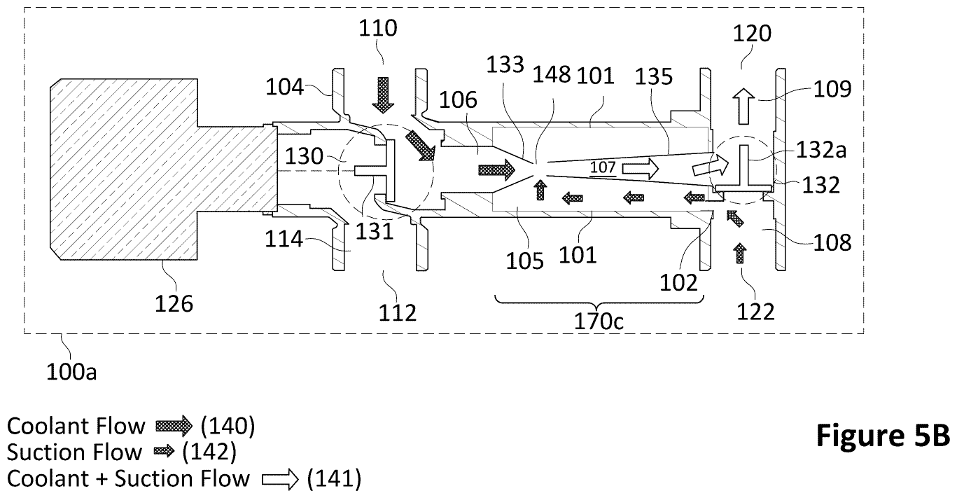

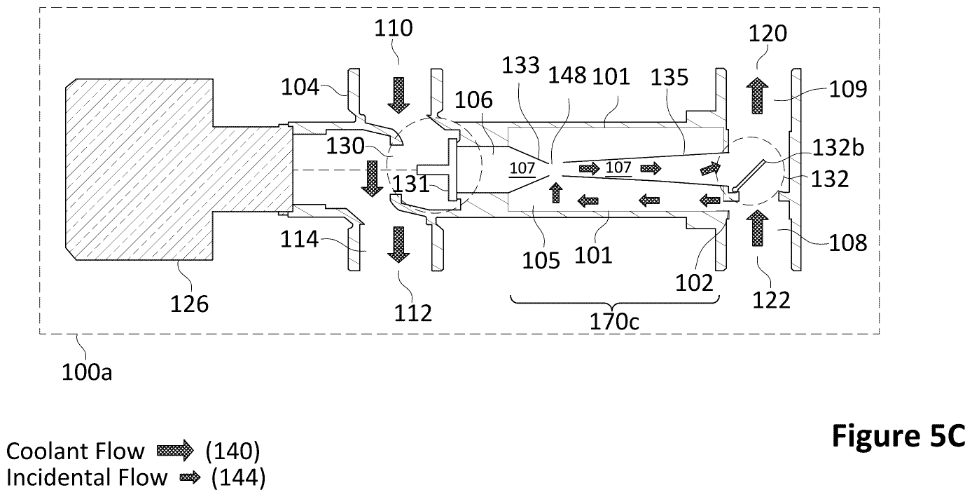

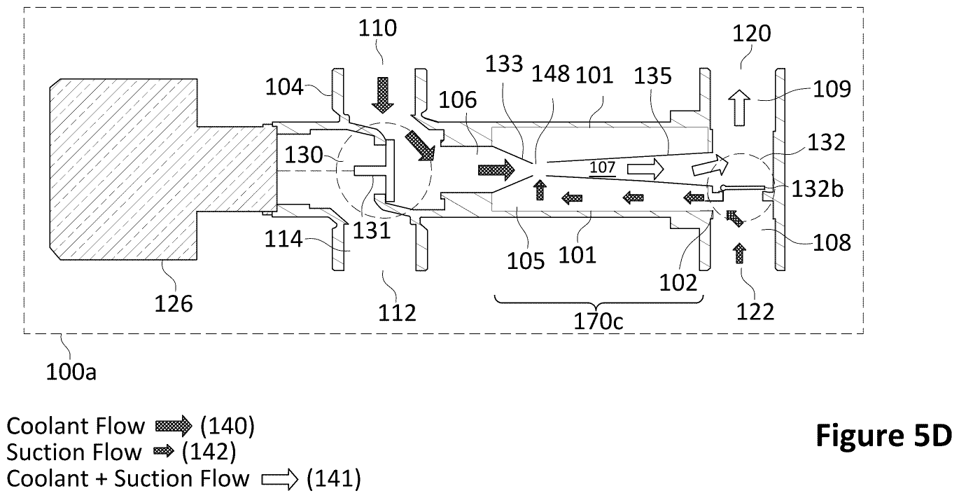

Referring now to FIGS. 5A-5D, there are illustrated cross-sectional views of a preferred embodiment of the coolant control apparatus 100a schematically depicted in FIGS. 1A-1B with the specific adoption of the venturi apparatus 170c depicted in FIGS. 4D-4E in place of the generally depicted venturi apparatus 170 of FIGS. 1A-1B.

As illustrated both schematically in FIGS. 1A-1B and physically in FIGS. 5A-5D, the coolant control apparatus 100a comprises the intake passageway 104, supply passageway 114, bypass passageway 106, return passageway 108, return check valve 132, exhaust passageway 109 and venturi apparatus 170 shown schematically in FIGS. 1A-1B, but now including the fluid jacket 101 and radial gap 148 shown in FIGS. 4D-4E (now denoted “170c”).

The operation of the coolant control apparatus 100a of FIGS. 5A-5D is set forth above in the descriptions corresponding to FIGS. 1A-1B and FIGS. 4D-4E, with FIGS. 5A and 5C corresponding to FIG. 1A, and FIGS. 5B and 5D corresponding to FIG. 1B. It will be noted that in all instances of the coolant control apparatus 100a shown in FIGS. 5A-5D the suction inlet 102 is coupled directly to the return passageway 108, thereby eliminating the suction passageway 116 included in FIGS. 1A-1B.

As illustrated in FIGS. 5A-5D, the apparatus 100a further comprises the three-way control valve 130 with a valve diaphragm 131 in communication with the valve actuator 126, which provides for selectively holding the valve diaphragm 131 (i) in the position shown in FIGS. 5A and 5C for directing coolant flow 140 from the intake passageway 104 to the supply passageway 114, or (ii) in the position shown in FIGS. 5B and 5D for directing coolant flow 140 from the intake passageway 104 to the bypass passageway 106.

As further illustrated in FIGS. 5A and 5B, in some embodiments, the return check valve 132 comprises a poppet 132a, which is adapted to allow coolant flow 140 from the return passageway 108 to the exhaust passageway 109 when subjected to coolant flow 140 from an external device, e.g., device 300 (not shown), as illustrated in FIG. 5A, and prevent a backflow of coolant from the exhaust passageway 109 to the return passageway as illustrated in FIG. 5B.

As illustrated in FIGS. 5C and 5D, in a preferred embodiment of the coolant control apparatus 100a, the return check valve 132 comprises a hinged swing gate 132b, which is adapted to swing open as shown in FIG. 5C to allow coolant flow 140 from the return passageway 108 to the exhaust passageway 109 when subjected to coolant flow 140 from an external device, e.g., device 300 (not shown), and swing closed as shown in FIG. 5D to prevent a backflow of coolant from the exhaust passageway 109 to the return passageway 108.

Placement of the swing gate 132b in a position such that the coolant flow 140 through the bypass passageway 106 forces the swing gate 132b to a closed position can eliminate the need for a closing spring, as usually required for typical check valves.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. An apparatus for controlling circulation of a fluid to and from an external device, comprising;
an intake passageway adapted to receive said fluid therein and transmit a flow of said fluid therethrough;
a supply passageway adapted to selectively receive and transmit said flow of said fluid from said intake passageway to said external device;
a bypass passageway adapted to selectively receive said flow of said fluid from said intake passageway and transmit said flow of said fluid therethrough;
a venturi apparatus coupled to said bypass passageway, said venturi apparatus comprising a venturi passageway adapted to receive said flow of said fluid from said bypass passageway and transmit said flow of said fluid therethrough, said venturi apparatus adapted to generate a suction force when said flow of said fluid is said transmitted through said venturi passageway; and
fluid control means for selectively directing said flow of said fluid transmitted through said intake passageway into said supply passageway and, thereby, to said external device, or transmitted through said intake passageway into said bypass passageway and, thereby, into and through said venturi apparatus,
said fluid control means positioned upstream of said venturi apparatus.

2. The apparatus of claim 1, wherein said fluid control means comprises a three-way fluid control valve in fluid communication with said intake passageway, said supply passageway and said bypass passageway and adapted to direct said flow of said fluid said transmitted through said intake passageway into said supply passageway and, thereby, to said external device, or direct said flow of said fluid said transmitted through said intake passageway into said bypass passageway and, thereby, into and through said venturi apparatus.

3. The apparatus of claim 1, wherein said fluid control means comprises first and second two-way fluid control valves, said first two-way fluid control valve in fluid communication with said intake passageway and said supply passageway and adapted to direct said flow of said fluid said transmitted through said intake passageway into said supply passageway and, thereby, to said external device, and said second two-way fluid control valve in fluid communication with said intake passageway and said bypass passageway and adapted to said direct said flow of said fluid transmitted through said intake passageway into said bypass passageway and, thereby, into and through said venturi apparatus.

4. The apparatus of claim 1, wherein said venturi passageway comprises a leading conical passageway comprising a gradually decreasing cross-sectional area, a trailing conical passageway comprising a gradually increasing cross-sectional area and a fluid restriction therebetween, wherein said suction force is created.

5. The apparatus of claim 4, wherein said venturi apparatus further comprises a fluid jacket external to and at least partially surrounding said venturi passageway, said fluid jacket sized and configured to receive and contain said fluid therein, said fluid jacket coupled to said fluid restriction of said venturi apparatus, whereby said fluid jacket is in fluid communication with said venturi passageway.

6. The apparatus of claim 5, wherein said fluid jacket is said coupled to said fluid restriction of said venturi apparatus by a radial gap.

7. The apparatus of claim 5, wherein said fluid jacket is said coupled to said fluid restriction of said venturi apparatus by a concentric gap.

8. The apparatus of claim 1, wherein said apparatus further comprises a return passageway coupled to said external device, said return passageway adapted to receive said fluid from said external device.

9. The apparatus of claim 8, wherein said apparatus further comprises a suction passageway coupled to said return passageway and said fluid jacket of said venturi apparatus.

10. The apparatus of claim 9, wherein, when said venturi apparatus said generates said suction force, at least a first portion of said fluid in said return passageway is drawn from said return passageway, into and through said suction passageway and said venturi apparatus, and into said bypass passageway and combined with said flow of said fluid flowing therethrough.

11. The apparatus of claim 9, wherein said suction passageway comprises first valve means for preventing a backflow of said fluid through said suction passageway.

12. The apparatus of claim 11, wherein said return passageway comprises second valve means for preventing a backflow of said fluid through said return passageway.

13. The apparatus of claim 12, wherein said second valve means comprises a swing gate comprising a first position, whereby said flow of said fluid through said bypass passageway and said venturi apparatus forces said swing gate to a second position to prevent said backflow of said fluid through said return passageway without assistance of a spring.

14. An apparatus for controlling circulation of a fluid to and from an external device, comprising:
fluid control means and a venturi apparatus, said fluid control means adapted to selectively direct a first flow of said fluid to said external device and concomitantly abate said first flow of said fluid to said venturi apparatus, or direct a second flow of said fluid to said venturi apparatus and concomitantly abate said second flow of said fluid to said external device,
said venturi apparatus comprising a leading conical passageway with a gradually decreasing cross-sectional area, a trailing conical passageway with a gradually increasing cross-sectional area, and a gap disposed between said leading and trailing conical passageways, said venturi apparatus adapted to generate a suction force proximate said gap when said second flow of said fluid is said transmitted therethrough,
said venturi apparatus further comprising a fluid jacket in communication with said gap of said venturi apparatus, whereby said suction force is transmitted therethrough,
said fluid jacket also in fluid communication with said external device, whereby said suction force retracts at least a portion of said fluid therefrom.

15. The apparatus of claim 14, wherein said gap disposed between said leading and trailing conical passageways of said venturi apparatus comprises a radial gap.

16. The apparatus of claim 14, wherein said gap disposed between said leading and trailing conical passageways of said venturi apparatus comprises a concentric gap.

17. A method for controlling circulation of a fluid to and from an external device, comprising the steps of:
(i) providing an apparatus comprising an intake passageway, a supply passageway, a bypass passageway and a venturi apparatus,
said intake passageway adapted to selectively receive said fluid therein and transmit a flow of said fluid therethrough,
said supply passageway coupled to said intake passageway and adapted to selectively receive and transmit said flow of said fluid from said intake passageway to said external device in fluid communication therewith,
said bypass passageway coupled to said intake passageway and adapted to selectively receive said flow of said fluid from said intake passageway and transmit said flow of said fluid therethrough,
said venturi apparatus coupled to said bypass passageway and comprising a venturi passageway adapted to receive said flow of said fluid from said bypass passageway and transmit said flow of said fluid therethrough, said venturi passageway comprising a leading conical passageway with a gradually decreasing cross-sectional area, a trailing conical passageway with a gradually increasing cross-sectional area, and a gap disposed between said leading and trailing conical passageways, said venturi apparatus adapted to generate a suction force proximate said gap when said flow of said fluid is said transmitted through said venturi passageway,
said apparatus further comprising fluid control means for selectively directing said flow of said fluid said transmitted through said intake passageway into and through said supply passageway and, thereby, to said external device, or directing said flow of said fluid said transmitted through said intake passageway into and through said bypass passageway and, thereby, into and through said venturi passageway,
said fluid control means positioned upstream of said venturi apparatus;
(ii) transmitting a first flow of first fluid into said intake passageway of said venturi apparatus; and
(iii) directing said first flow of said first fluid transmitted through said intake passageway of said venturi apparatus into said supply passageway and, thereby, to said external device with said fluid control means.

18. The method of claim 17, wherein said gap disposed between said leading and trailing conical passageways of said venturi apparatus comprises a radial gap.

19. The method of claim 17, wherein said gap disposed between said leading and trailing conical passageways of said venturi apparatus comprises a concentric gap.

20. The method of claim 17, wherein said fluid control means comprises a three-way fluid control valve in fluid communication with said intake passageway, said supply passageway and said bypass passageway and adapted to said direct said first flow of said first fluid transmitted through said intake passageway into said supply passageway and, thereby, to said external device, or direct said first flow of said first fluid transmitted through said intake passageway into said bypass passageway and, thereby, into and through said venturi passageway.

21. The method of claim 17, wherein said fluid control means comprises first and second two-way fluid control valves, said first two-way fluid control valve in fluid communication with said intake passageway and said supply passageway and adapted to said direct said first flow of said first fluid transmitted through said intake passageway into said supply passageway and, thereby, to said external device, and said second two-way fluid control valve in fluid communication with said intake passageway and said bypass passageway and adapted to direct said first flow of said first fluid transmitted through said intake passageway into said bypass passageway and, thereby, into and through said venturi passageway.

22. The method of claim 17, wherein said venturi apparatus further comprises a fluid jacket external to and at least partially surrounding said venturi passageway, said fluid jacket sized and configured to receive and contain said first fluid therein, said fluid jacket coupled to said gap of said venturi apparatus and, thereby, to said venturi passageway.

23. The method of claim 22, wherein said apparatus further comprises a return passageway coupled to said external device, said return passageway adapted to receive said first fluid from said external device and transmit said first fluid therethrough.

24. The method of claim 23, wherein said apparatus further comprises a suction passageway coupled to said return passageway and said venturi apparatus.

24. The method of claim 24, wherein, after said step of directing said first flow of said first fluid transmitted through said intake passageway into said supply passageway and, thereby, to said external device with said fluid control means, said method further comprises the steps of ceasing said directing of said first flow of said first fluid into said supply passageway and directing said first flow of said first fluid transmitted through said intake passageway into and through said bypass passageway, wherein a first suction force is created and at least a first portion of said first fluid in said return passageway is drawn from said return passageway, into and through said suction passageway, said fluid jacket and said venturi apparatus, and into and through said bypass passageway and combined with said first fluid flowing therethrough.
